(19) United States
(12) Patent Application Publication
(10) Pub. No.: US 2026/0068016 A1
(43) Pub. Date: Mar. 5, 2026

(54) REGULAR POWER DETECTION AND EMERGENCY LIGHTING IN A NETWORKED SYSTEM

(71) Applicant: SIGNIFY HOLDING B.V., EINDHOVEN (NL)

(72) Inventors: AMEYA VILAS AINAPURE, ATLANTA, GA (US); MILAN NILESH DOSHI, CUMMING, GA (US); DAVID MING KO, ONTARIO (CA); MICHAEL PETRUS FRANCISCUS VERSCHOOR, GELDROP (NL)

(21) Appl. No.: 19/299,734

(22) Filed: Aug. 14, 2025

Related U.S. Application Data
(60) Provisional application No. 63/687,342, filed on Aug. 27, 2024.

(30) Foreign Application Priority Data
Sep. 18, 2024 (EP) 24200953.8

(51) Int. Cl. H05B 47/17; H05B 47/155; H05B 47/16; H05B 47/165

(52) U.S. Cl. CPC H05B 47/172; H05B 47/155; H05B 47/16; H05B 47/165

(57) ABSTRACT

A method for controlling a light source includes determining, by a processor coupled to a memory having a set of memory locations, receipt of a set of beacon signals from a set of power-sensing devices, each beacon signal associated with one of the set of power-sensing devices, each one of the set of power-sensing devices associated with one of the memory locations. The method includes, upon receipt of each beacon signal, storing, by the processor, an indicator value in the memory location associated with the power-sensing device. The method includes determining, by the processor, a presence of an emergency mode based on the values of the set of memory locations. The method further includes controlling, by the processor, the light source based on the presence of the emergency mode. The method includes updating, by the processor, the values of the set of memory location.

### FIELD OF THE INVENTIONS

The present disclosure relates generally to the field of lighting devices. More specifically, the present disclosure is directed to regular power detection in a lighting control network.

### BACKGROUND OF THE INVENTION

User-configurable networked lighting control systems often include wired and/or wireless devices connected to a communication medium. The devices generally are smart lighting fixtures that are connected to an emergency power source. The devices’ firmware can facilitate power failure detection and initiation of an emergency mode in which they provide maximum output light levels to aid in various emergency protocols and procedures. As part of the system, some of the devices in the network are connected to regular power lines, for example regular power provided by a utility through the power grid, and their firmware has the capability to detect if regular power is operational/running. These devices, once assigned by the user to act as regular-power sensing devices, send a beacon signal at a periodic interval that propagates throughout the network reaching all the devices. If these devices experience a power failure, their firmware is no longer able to send out the beacon.

In traditional lighting control systems, monitoring beacons from various regular-power sensing devices requires multiple independent timers running on the firmware of the lighting controller to monitor the status of each regular-power sensing device. With a high number of regular-power sensing devices, monitoring these beacons becomes complex and time-consuming. Therefore, these traditional monitoring methods are not scalable. In addition, traditional regular-power monitoring systems often do not allow for flexibility to adjust the aggressiveness of the power outage detection logic.

### SUMMARY OF THE INVENTION

The deficiencies of the prior art are overcome by providing techniques to overcome the disadvantage of requiring multiple independent timers on the firmware of a lighting controller, such as a controller of an emergency lighting fixture, to monitor status of each regular- power sensing device. The techniques described herein allow for evaluation for all power sensing devices to be performed at the same evaluation period, rendering the detection less complex and much more scalable. In addition, the techniques disclosed herein are very granular and provide flexibility to tweak the aggressiveness of the power-outage detection logic simply by varying the size of individual registers corresponding to the count of regular-power sensing devices.

In accordance with an embodiment of the present disclosure, a controller (102) for controlling a light source (114) includes a processor (104) coupled to a memory (106) having a set of memory locations. The processor (104) is configured to determine receipt of a set of beacon signals from a set of power-sensing devices (112), each beacon signal associated with one of the set of power-sensing devices, each one of the set of power sensing devices (112) associated with one of the memory locations. The processor (104) is configured to, upon receipt of each beacon signal, store an indicator value in the memory location associated with the power sensing device. The processor (104) is configured to determine a presence of an emergency mode based on the values of the set of memory locations. The processor (104) is configured to control, via the output interface (110), the light source (114) based on the presence of the emergency mode. The processor (104) is configured to update the values of the set of memory locations.

Alternatively, or in addition, the controller (102) may be part of the light source (114). Alternatively, or in addition, the set of power-sensing devices (112) may include a second light source.

Also alternatively, or in addition, the indicator value may be a 1 stored in a least significant bit of the memory location. The processor (104) may be configured to update the values of the set of memory locations by bitwise left-shifting each one of the set of memory locations by one bit. The processor (104) may be configured to determine the presence of the emergency mode based on at least one of the set of memory locations having a value of zero.

Alternatively, or in addition, each one of the set of memory locations may have a size corresponding to a desired reactivity of the controller to a power outage. The processor (104) may be configured to determine that the emergency mode is no longer present based on each one of the set of memory locations having a non-zero value.

In accordance with another embodiment of the present disclosure, a computer-implemented method includes determining, by a processor (104) coupled to a memory (106) having a set of memory locations, receipt of a set of beacon signals from a set of power-sensing devices (112), each beacon signal associated with one of the set of power-sensing devices, each one of the set of power-sensing devices associated with one of the memory locations. The method includes, upon receipt of each beacon signal, storing, by the processor (104), an indicator value in the memory location associated with the power-sensing device. The method includes determining, by the processor (104), a presence of an emergency mode based on the values of the set of memory locations. The method further includes controlling, by the processor (104), a light source (114) based on the presence of the emergency mode. The method includes updating, by the processor (104), the values of the set of memory locations.

Alternatively, or in addition, the set of power-sensing devices (112) may include a second light source.

Also alternatively, or in addition, the indicator value may be a 1 stored in a least significant bit of the memory location. Updating the values of the set of memory locations may include bitwise left-shifting each one of the set of memory locations by one bit. Determining the presence of the emergency mode may be based on at least one of the set of memory locations having a value of zero.

Further alternatively, or in addition, each one of the set of memory locations may have a size corresponding to a desired reactivity of the controller to a power outage. Determining the presence of the emergency mode may include determining that the emergency mode is no longer present based on each one of the set of memory locations having a non-zero value.

### BRIEF DESCRIPTION OF THE DRAWINGS

To easily identify the discussion of any particular element or act, the most significant digit or digits in a reference number refer to the figure number in which that element is first introduced.

FIG. 1 shows a block diagram of a system for controlling a light source in accordance with one embodiment.

FIG. 2 shows a flowchart of a method for controlling a light source in accordance with one embodiment.

FIG. 3 is a flowchart of a method for controlling a light source in accordance with one embodiment.

### DETAILED DESCRIPTION OF THE EMBODIMENTS

All illustrations of the drawings are for the purpose of describing selected versions of the present disclosure and are not intended to limit the scope of the claimed inventions.

As used throughout the present disclosure and the claims, a “set” includes at least one member.

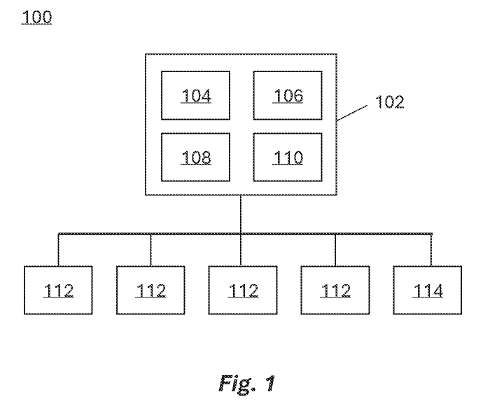

FIG. 1 shows a block diagram of a representative system 100 for controlling a light source in accordance with one embodiment and usable to implement the present disclosure. System 100 includes a controller 102. The controller 102 may include components, such as a processor 104, a memory 106, an input interface 108, and an output interface 110. The memory 106, input interface 108, and output interface 110 are communicatively coupled to the processor 104. While input interface 108 and output interface 110 are shown as separate components, it is expressly contemplated that a single component may provide input and output interface functionality. For example, a network interface communicatively coupled to processor 104 may be used to transmit data to and receive data from a network. The memory 106 has a set of memory locations (not shown).

Input interface 108 and output interface 110 may provide a connection to any type of network. The network may be a wide area network (for example, the Internet) or a local area network. Input interface 108 and output interface 110 may include a wired interface (for example, ethernet) and/or a wireless interface implementing various RF data communication standards, such as Wi-Fi, Bluetooth, Zigbee, Z-Wave, or cellular data network standards (for example, 3G, 4G, 5G, 60 GHz, or LTE).

Some implementations of controller 102 include electronic components, such as microprocessors, storage and memory that store computer program instructions in a computer readable storage medium (for example, a non-transitory computer readable medium).

Many of the features described in this specification can be implemented as processes that are specified as a set of program instructions encoded on a computer readable storage medium. When these program instructions are executed by one or more processors, they cause the processors to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processor 104 may provide various functionality for controller 102, including any of the functionality described herein as being performed by a controller, or other functionality associated with controlling light fixtures.

It will be appreciated that controller 102 is illustrative and that variations and modifications are possible. Controllers used in connection with the present disclosure may have other capabilities not specifically described here. Further, while controller 102 is described with reference to particular blocks, it is to be understood that these blocks are defined for convenience of description and are not intended to imply a particular physical arrangement of component parts. For instance, different blocks may be located in the same physical and/or logical component. The blocks need not correspond to physically distinct components. Blocks can be configured to perform various operations, for example, by programming a processor or providing appropriate control circuitry, and various blocks might or might not be reconfigurable depending on how the initial configuration is obtained. Implementations of the present disclosure may be realized in a variety of apparatus, including electronic devices implemented using any combination of circuitry and software.

System 100 further includes one or more power-sensing devices 112 and at least one light source 114. While one light source 114 is shown, system 100 may include more than one light source controlled by controller 102. Similarly, while four power-sensing devices 112 are shown, the system 100 may include any number of power-sensing devices. For example, system 100 may include only a single power-sensing device 112, or system 100 may include more than one power-sensing device 112. Because of the highly scalable nature of the techniques disclosed herein, a large number of power-sensing devices 112 may be part of system 100. In some embodiments, the light source 114 may also function as a power-sensing device 112. In other embodiments, a power-sensing device 112 may be integrated into the controller 102. The power-sensing devices 112 may be electrically coupled to regular power, such as power received from a utility over the power grid. However, it is expressly noted that regular power refers to the power that the controller 102 and the power-sensing devices 112 are usually powered by. Therefore, regular power may also refer to power received from a battery, a generator, or any other power source.

Controller 102 and light source 114 may be electrically connected to emergency power in addition to regular power. Emergency power may refer to power received from a battery, a generator, or any other power source. In some embodiments, emergency power may refer to power received from a utility that is different from regular power. For example, emergency power may be received from a utility over a different cable than regular power, emergency power may refer to a different phase of utility power than the phase used for regular power, etc.

The controller 102 may be implemented in a unit separate from the light source 114 and from the power-sensing devices 112, such as a wall panel, a desktop computer terminal, or even a portable terminal, such as a laptop, a tablet, or a smartphone. Alternatively, the controller 102 may be incorporated into the same unit as the power-sensing device 112 and/or the same unit as the light source 114. Further, the controller 102 may be implemented in a single unit or in the form of distributed functionality distributed amongst multiple separate units (for example, a control function distributed amongst the light sources 114 or amongst the light sources 114 and the sensors 112).

Furthermore, the controller 102 may be implemented in the form of software stored on a memory 106 (comprising one or more memory devices) and arranged for execution on a processor 104 (comprising one or more processing units), or the controller 102 may be implemented in the form of dedicated hardware circuitry, or configurable or reconfigurable circuitry, such as a PGA or FPGA, or any combination of these.

Regarding the various communication involved in implementing the functionality discussed below, to enable the controller 102 to receive the sensor readings from the power-sensing devices 112 and to control the light output of the light source 114, these may be implemented in by any suitable wired and/or wireless means, for example, by means of a wired network, such as an ethernet network, a DMX network or the Internet, or by means of a wireless network, such as a local (short range) RF network, for example, a Wi-Fi, ZigBee or Bluetooth network, or any combination of these and/or other means.

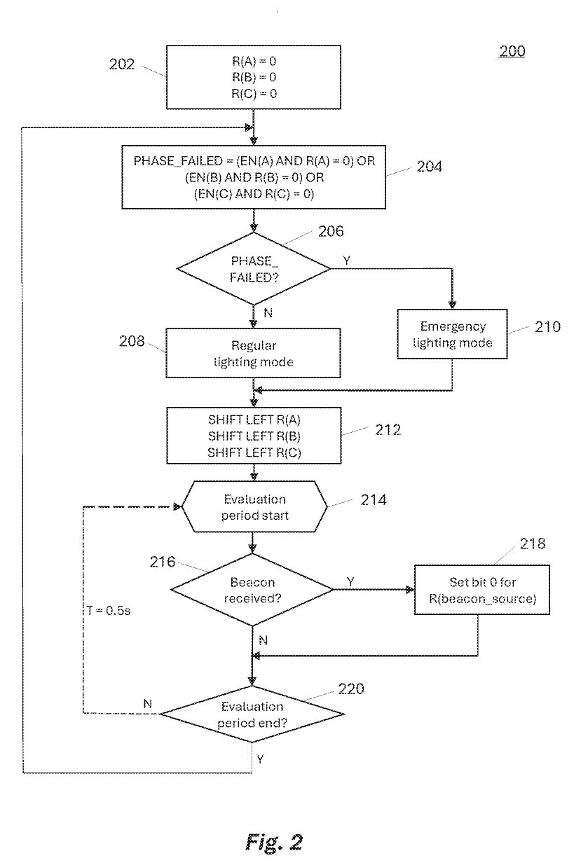

FIG. 2 shows a flowchart of a method 200 for controlling a light source in accordance with one embodiment. The method 200 may, for example, be executed by processor 104 of controller 102 and may be utilized to control a light source 114 based on data received from power-sensing devices 112. As stated above, any number of power-sensing devices 112 and any number of light sources 114 may be used by method 200. Illustratively, controller 102 may control light source 114 based on a presence of an emergency mode. Controller 102 may operate in either a regular mode or an emergency mode. For example, controller 102 may operate in the regular mode while regular power is present, and controller 102 may operate in the emergency mode when regular power has not been present for a predetermined time, as described below.

Memory 106 has a set of memory locations configured to store data related to the power-sensing devices 112, Memory 106 may have a specific memory location associated with each one of the power-sensing devices 112. For example, if system 100 includes three power-sensing devices A, B, and C, memory 106 may include three memory locations. The memory locations may be referred to as registers R. Register R(A) may be associated with power-sensing device A, register R(B) may be associated with power-sensing device B, and register R(C) may be associated with power-sensing device C.

The registers R may have any suitable size. The size of the registers corresponds to a desired reactivity of method 200. In other words, the size of the registers corresponds to how fast the controller 102 reacts to an outage of regular power. While a switchover to an emergency mode, including activation of light source 114, may be desired to happen quickly, the controller 102 also should not oscillate between regular mode and emergency mode in case of short-lived failures of regular power. In the example shown in FIG. 2, the time-out period TMO is selected to be 7.5 seconds. In other words, the controller 102 enters the emergency mode when regular power has been absent for 7.5 seconds. The evaluation period T is set to 0.5 seconds, i.e., each 0.5 seconds the value of the registers R is checked and updated as described below. The size of the registers R is then determined as TMO/T bits. In the example of FIG. 2, the size of the registers R is 15 bits.

Memory 106 may also include additional memory locations, for example to enable or disable monitoring of a specific power-sensing device 112. Illustratively, memory 106 may include three additional memory locations EN(A), EN(B), and ENC(C) corresponding to the power-sensing devices A, B, and C, respectively. EN(A), EN(B), and EN(C) may be Boolean variables. The controller 102 may include power-sensing device A in its determination of emergency mode if EN(A) is set to true, power-sensing device B if EN(B) is set to true, and power-sensing device C if EN(C) is set to true. Any power-sensing device that has its associated Boolean variable set to false may be ignored in determining whether to enter or exit emergency mode.

At step 202, the controller 102 may set the registers R(A), R(B), and R(C) to an initial value of 0. It is also contemplated that the controller may set the registers to an initial value different from 0 to avoid entering emergency mode shortly after the start of the method.

At step 204, the controller 102 determines whether regular power is present by evaluating the registers associated with and corresponding to the various power-sensing devices 112. As described above, the controller may only evaluate the registers associated with the power-sensing devices that have their corresponding Boolean variable EN set to true. This allows the user to exclude power-sensing devices that may be faulty, on a power circuit that is disconnected, or in any other way undesirable for evaluation. Alternatively, there may be no Boolean variables EN, and the controller 102 may evaluate the registers associated with all power-sensing devices 112. The controller 102 may generate one Boolean value, for example PHASE_FAILED, as a result of the evaluation. PHASE_FAILED may be zero or false if regular power has been absent for the time-out period TMO, and PHASE_FAILED may be true or non-zero if regular power is present or has been present during the time-out period TMO. In the example shown in FIG. 2, PHASE_FAILED is calculated as:

PHASE_FAILED := (EN(A) and R(A)=0) OR (EN(B) AND R(B)=0) OR (EN(C) AND R(C)=0)

As can be seen, PHASE_FAILED is true if any one of the registers R(A), R(B), R(C) has a value of zero and is enabled for evaluation. This means that if only one of the power-sensing devices 112 has not detected regular power during the time-out period TMO, PHASE_FAILED is set to true.

In step 206, the controller 102 determines a presence of the emergency mode based on the value of PHASE_FAILED, i.e., based on the values of the registers R associated with the power-sensing devices 112. If PHASE_FAILED is non-zero or true, the controller, in step 210, enters the emergency mode if currently in the regular mode, or stays in the emergency mode if already in the emergency mode. If PHASE_FAILED is zero or false the controller, in step 208, enters the regular mode if currently in the emergency mode, or stays in the regular mode, or normal lighting mode, if already in the regular mode.

The controller actions associated with entering emergency mode in step 210 or entering regular mode in step 208 may be selected in any suitable way. For example, the controller 102 may control light source 114 to cause it to turn on or otherwise increase its light output when entering the emergency mode. The controller 102 may also control light source 114 to cause it to turn off or otherwise decrease its light output when entering the regular mode. The controller 102 may control light source 114 for example through output interface 110 and a network that the controller and the light source are communicatively coupled to. Since light source 114 may be connected to emergency power, the light source therefore may provide illumination during an outage of regular power. When regular power has been restored and emergency illumination is no longer needed, the controller 102 then may cause the light source 114 to turn off.

In step 212, the controller 102 may bitwise shift the values of the registers by one bit to the left. This shift may be performed on each one of the registers. During the shift, the most significant bit is discarded, and the least significant bit is set to 0. For example, a value of register R(A) of 100101111111110 may shift to 001011111111100.

Steps 214, 216. 218, and 220 are part of the controller’s evaluation period. These steps are performed periodically as determined by the evaluation period T. Illustratively, the evaluation period T may be set to 0.5 seconds, i.e., the controller may perform steps 214, 216, 218, and 220 every 0.5 seconds. Step 214 marks the start of the evaluation. The controller 102 may, for example, set a timer to run for the desired evaluation period. If the evaluation period is 0.5 seconds, the controller 102 may set a countdown timer to 0.5 seconds and start the timer.

In step 216, the controller 102 determines if a beacon signal has been received from a respective power-sensing device 112, for example at input interface 108. The controller 102 may receive the beacon signal, for example, over a network that the controller and the power-sensing devices are communicatively coupled to. The power-sensing devices 112 may be configured to periodically transmit beacon signals to the controller 102 while they sense that regular power is present at the respective power-sensing device. The power-sensing devices may stop transmitting beacon signals when regular power is absent, for example because the respective power-sensing device now has lost its power source and is therefore unable to transmit a beacon. The period for transmitting beacon signals may be the same as the evaluation period T, or it may be a suitable shorter or longer period.

In step 218, if a beacon signal has been received, the controller 102 may set the least significant bit of the register associated with the power-sensing device to 1. Illustratively, if a beacon from power-sensing device A has been received, the controller may set the least significant bit of R(A) to 1. In an example, a value of R(A) of 100101111111110 would be set to 100101111111111.

If no beacon signal has been received from the corresponding power-sensing device, the controller 102 may not change the value of the register associated with that power-sensing device.

Step 220 marks the end of the evaluation. If there is still time left on the timer, i.e. if the evaluation period has not expired, the controller may continue to evaluate for received beacon signals and go back to step 214. If the evaluation period has expired, the controller may go back to step 204.

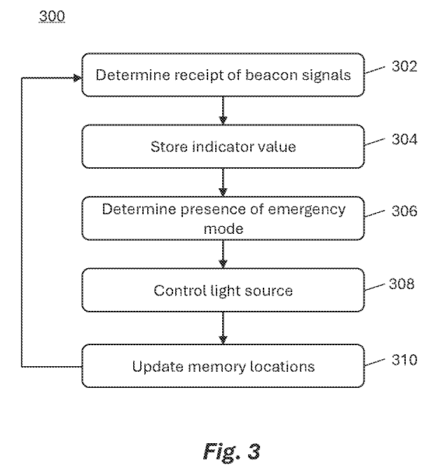

FIG. 3 is a flowchart of a method 300 for controlling a light source in accordance with one embodiment. The method shown in FIG. 3 is substantially similar to the method 200 shown in FIG. 2 and may, for example, be executed by processor 104 of controller 102 coupled to memory 106 to control a light source 114 based on data received from power-sensing devices 112.

In step 302, the processor 104 determines receipt of a set of beacon signals from the set of power-sensing devices as described above with reference to step 216. Each beacon signal is associated with one of the set of power-sensing devices. Each one of the set of power-sensing devices is associated with one of the memory locations.

In step 304, upon receipt of a beacon signal, the processor 104 stores an indicator value in the memory location associated with the respective power-sensing device, as described above with reference to step 218. The indicator value may, for example, be the least significant bit of the corresponding memory location set to 1.

In step 306, the processor 104 determines a presence of an emergency mode based on the values of the set of memory locations, as described above with reference to step 206.

In step 308, the processor 104 controls a light source based on the presence of the emergency mode, as described above with reference to steps 208 and 210.

In step 310, the processor 104 updates the values of the memory locations, as described above with reference to step 212. As shown above, the updating may include bitwise shifting the values of the memory locations to the left by one bit. After updating the memory locations, the processor 104 may go back to step 302 and repeat the method 300.

While the disclosure has been illustrated and described in detail in the drawings and foregoing description, such illustration and description are to be considered illustrative or exemplary and not restrictive. The claimed inventions are not limited to the disclosed embodiments.

Other variations to the disclosed embodiments can be understood and effected by those skilled in the art in practicing the claimed inventions, from a study of the drawings, the disclosure, and the appended claims.

In the claims, the word “comprising” does not exclude other elements or steps, and the indefinite article “a” or “an” does not exclude a plurality.

A single processor or other unit may fulfill the functions of several items recited in the claims.

The mere fact that certain measures are recited in mutually different dependent claims does not indicate that a combination of these measures cannot be used to obtain an advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A controller for controlling a light source, the controller comprising:
a processor coupled to a memory having a set of memory locations,
the processor being configured to:
determine receipt of a set of beacon signals from a set of power-sensing devices, each beacon signal associated with one of the set of power-sensing devices, each one of the set of power-sensing devices associated with one of the memory locations;
upon receipt of each beacon signal, store an indicator value in the memory location associated with the power-sensing device;
determine a presence of an emergency mode based on the values of the set of memory locations;
control the light source based on the presence of the emergency mode; and
update the values of the set of memory locations.

2. The controller of claim 1, wherein the controller is part of the light source.

3. The controller of claim 1, wherein the set of power-sensing devices includes a second light source.

4. The controller of claim 1, wherein the indicator value is a 1 stored in a least significant bit of the memory location.

5. The controller of claim 1, wherein the processor is configured to update the values of the set of memory locations by bitwise left-shifting each one of the set of memory locations by one bit.

6. The controller of claim 1, wherein the processor is configured to determine the presence of the emergency mode based on at least one of the set of memory locations having a value of zero.

7. The controller of claim 1, wherein each one of the set of memory locations has a size corresponding to a desired reactivity of the controller to a power outage.

8. The controller of claim 1, wherein the processor is configured to determine that the emergency mode is no longer present based on each one of the set of memory locations having a non-zero value.

9. A method comprising:
determining, by a processor coupled to a memory having a set of memory locations, receipt of a set of beacon signals from a set of power-sensing devices, each beacon signal associated with one of the set of power-sensing devices, each one of the set of power-sensing devices associated with one of the memory locations;
upon receipt of each beacon signal, storing, by the processor, an indicator value in the memory location associated with the power-sensing device;
determining, by the processor, a presence of an emergency mode based on the values of the set of memory locations;
controlling, by the processor, a light source based on the presence of the emergency mode; and
updating, by the processor, the values of the set of memory locations.

10. The method of claim 9, wherein the set of power-sensing devices includes a second light source.

11. The method of claim 9, wherein the indicator value is a 1 stored in a least significant bit of the memory location.

12. The method of claim 9, wherein updating the values of the set of memory locations includes bitwise left-shifting each one of the set of memory locations by one bit.

13. The method of claim 9, wherein determining the presence of the emergency mode is based on at least one of the set of memory locations having a value of zero.

14. The method of claim 9, wherein each one of the set of memory locations has a size corresponding to a desired reactivity of the controller to a power outage.

15. The method of claim 9, wherein determining the presence of the emergency mode includes determining that the emergency mode is no longer present based on each one of the set of memory locations having a non-zero value.
